(19) United States
(12) Patent Application Publication
(10) Pub. No.: US 2011/0048283 A1
(43) Pub. Date: Mar. 3, 2011

(54) LOW-VOLATILITY COMPOUNDS FOR USE IN FORMING DEPOSITED LAYERS

(76) Inventors: Kenneth Aitchison, Los Gatos, CA (US); Atul Athalye, San Marcos, CA (US); Ce Ma, San Diego, CA (US)

(21) Appl. No.: 12/671,594

(22) PCT Filed: Jul. 15, 2008
(86) PCT No.: PCT/US08/70051

§ 371 Date: Oct. 25, 2010

Related U.S. Application Data
(60) Provisional application No. 60/963,053, filed on Aug. 2, 2007.

(51) Int. Cl. C09D 1/00

(52) U.S. Cl. 106/287.21

(57) ABSTRACT

The present invention relates to the use of low-volatility compounds in forming deposited layers and to methods for accomplishing such deposition. Particular applicability is in the field of depositing layers for semiconductor devices. A solution made up of low vapor pressure solutes (source materials) and solvents, wherein the solvents have a vapor pressure several orders of magnitude lower than that of the solute is described. The solutions are introduced to a vaporization apparatus configured to enable rapid and efficient vaporization of the solute with minimum evaporation of solvent and minimum decomposition of solute.

### FIELD OF THE INVENTION

The present invention relates to the use of low-volatility compounds in forming deposited layers and methods for accomplishing such deposition.

The present invention is particularly directed to the deposition of layers for semiconductor devices.

### BACKGROUND OF THE INVENTION

Numerous industrial applications require thin films of single elements, alloys, binary, ternary or quaternary mixtures. In particular, semiconductor devices are typically comprised of a number of thin layers of differing compositions. One way of making thin films is by Chemical Vapor Deposition (CVD), in which deposition reactions are activated by thermal, plasma, photolytic or surface catalytic mechanisms. In typical CVD processes, a compound containing some or all of the desired components of the thin film is vaporized and transported to a reaction chamber where the deposition of the thin film takes place on a substrate. Another common method of depositing thin films is by atomic layer deposition (ALD). ALD processes are the enabling technology for next generation conductor barrier layers, high-k gate dielectric layers, high-k capacitance layers, capping layers, and metallic gate electrodes in silicon wafer processes. ALD has also been applied in other electronics industries, such as flat panel display, compound semiconductor, magnetic and optical storage, solar cell, nanotechnology and nanomaterials. A typical ALD process uses sequential precursor gas pulses to deposit a film one layer at a time. In particular, a first precursor gas is introduced into a process chamber and produces a monolayer by reaction at the surface of a substrate in the chamber. A second precursor is then introduced to react with the first precursor and form a monolayer of film made up of components of both the first precursor and second precursor.

While a wide variety of compounds or precursors (source materials) can be used in CVD and ALD processes, there are limitations. Some compounds decompose when heated to temperatures high enough to deliver useful quantities to the deposition chamber. Other compounds are unstable when pure and many potential source materials are very sensitive to exposure to air or moisture. Some source materials are solids and are therefore difficult to deliver in reproducible quantities. There have been several proposed solutions to these problems. For example, source materials may be dissolved in a solvent to maintain stability or provide reproducibility as a liquid and then the resulting solution is sprayed into a vaporization chamber. This approach may make it easier to vaporize the solute but there may be a need to separate the solute vapors from solvent vapors. This is necessary because the presence of solvent molecules may undesirably effect the deposited layer. Also, the effluent treatment system of a CVD or ALD process may be taxed by the presence of excess solvent vapor.

Therefore, there remains a need in the art for new types of source materials for both CVD and ALD processes and for methods of using such source materials.

### SUMMARY OF INVENTION

The present invention overcomes the problems noted above, by providing a solution made up of low vapor pressure solutes (source materials) and solvents, wherein the solvents have a vapor pressure several orders of magnitude lower than that of the solute. The solutions of the present invention may be introduced to a vaporization apparatus configured to enable rapid and efficient vaporization of the solute with minimum evaporation of solvent and minimum decomposition of solute.

### DETAILED DESCRIPTION OF THE INVENTION

The present invention provides solutions made up of low vapor pressure solutes (source materials) and solvents, wherein the solvents have a vapor pressure several orders of magnitude lower than that of the solute. These solutions may then be introduced to a vaporization apparatus configured to enable rapid and efficient vaporization of the solute with minimum evaporation of solvent and minimum decomposition of solute.

The solute used in the solutions of the present invention may be any compound that has application as a source material for CVD or ALD processes. The solvent may be a single composition or a mixture of compositions. The solutions of the present invention must have the following properties. The solute must be completely soluble in the solvent over the temperature range applicable for the vaporization process. The solvent must have a vapor pressure two to three orders of magnitude lower than that of the solute over the applicable temperature range. The solvent must have a liquidus range from 0° C. to the highest temperature of the applicable temperature range; e.g. the solvent should remain in liquid form between 15° C. and 300° C. The solvent should show no appreciable thermal decomposition and no appreciable reactivity with the solute in the applicable temperature range of 15° C. to 300° C.

Other desirable properties of the solutions according to the present invention include low flammability, low toxicity and low environmental pollution properties. However, these properties are not absolutely necessary, as the risks associated therewith can be mitigated by other means, such as engineering or administrative control methods.

The concentration of solute in solvent may range from 0.001M up to the solubility limit of solute in solvent over the applicable temperature range.

More particularly, the useful range of concentration of solute is from 0.01M to about 1M or up to the saturation limit. The applicable temperature range has no lower boundary but does have an upper boundary at a temperature where the rate of vaporization of solute is significantly greater than the decomposition rate of solute over a time period necessary for vaporization. The preferred temperature range for vaporization is from 15° C. to 300° C. In this temperature range, decomposition of precursor or solvent is so low as to be not measurable. This ensures proper CVD or ALD operation within the given vaporization temperature range. The time period for vaporization can be determined by the vaporization apparatus, and may extend from nanoseconds to hours. The practical time period is on the order of milliseconds to 20 seconds, generally being equivalent to the residence time of the solution in the vaporization apparatus.

Some examples of solvents useful in the present invention include room temperature ionic liquids that have no measurable or very low vapor pressures from ambient up to 400° C. These room temperature ionic liquids act as a good solvent for metal or organometallic precursors. The ionic liquids contain a bulky cation and a smaller anion, wherein the cation can be imidazolium, pyridinium, ammonium or phosphonium. More particular cation examples include 1-ethyl-3-methylimidazolium (EMIM), 1-n-butyl-3-methylimidazolium (BMIM), and 1-butyl-1-methylpyrrolidinium bis(trifluoromethylsulfonyl)imide (BMP)TF₂N). The smaller anions can be chosen from tetrafluoroborate (BF₄), hexafluorophosphate (PF₆) and chlorine (Cl) for example. Metal precursors that dissolve in the ionic liquid solvent include HfCl₄, TaCl₅ and other metal inorganic and organic compounds. The vapor pressure ratio of the metal precursor solute over the solvent at vaporizer temperatures of 50° C. to 300° C. is greater than 100.

Stable emulsions of solute in solvent may also exist within the solubility limit and may be used in accordance with the present invention. However, it is important for emulsions that reproducible volume concentrations of the emulsion be deliverable to the vaporizer and that any emulsifying agent have the same properties as necessary for the solvent. It may be necessary to use a surfactant to enable emulsion use, and the solid precursor has to be in powder form.

The solutions according to the present invention may be prepared in a number of ways. For example, the solution may be prepared in predetermined concentrations and packaged for use. Alternatively, point of use preparation can be carried out by providing separate containers of solute and solvent and contacting them to provide a desired concentration in an appropriate apparatus. Point of use solution preparation can be carried out in either a batch mode or on a continuous basis, wherein continuous preparation is appropriate when the solutions decompose in storage.

The vaporization apparatus according to the present invention is designed to maximize the rate at which solute vapors are removed from the solution. This can be accomplished by exposing the solution to either a dynamic vacuum or to flowing gas at pressures in the range of the vapor pressure of the solution to nearly atmospheric pressure. In particular, the apparatus acts in an equivalent manner to a unit process known as gas/liquid stripping. Examples of methods and apparatus that may be employed include, but are not limited to; co-current flow in a packed tower; countercurrent flow in a packed tower; co-current spray tower; countercurrent spray tower; falling film; wiped film; plate or tray distillation apparatus; and bubbler/sparger. In general, this invention is applicable to any method wherein the surface area of the solution is maximized to enable the most rapid vaporization of the solute.

The following example is only one of many that can be used in accordance with the present invention and is provided for a more complete understanding of the invention. A controlled flow of solution made up of a solute in a solvent is transferred to the vaporizer stage of a deposition process. As the solution enters the vaporizer, the solution temperature is raised as quickly as possible to a temperature at which the vapor pressure of the solute is high enough to begin the stripping process, e.g. between 15° C. and 300° C. As the solute vaporizes, it is transported out of the vaporizer by either a dynamic vacuum use of a flowing carrier gas and the vaporized solute is delivered to a reaction chamber. The remaining solvent may be subsequently cooled and captured. The captured solvent may then be disposed of, or re-purified and reused to dissolve more solute.

There is a possibility that some solute may decompose during the vaporization stage. However, for many source materials, the decomposition products are less volatile than the original compound and therefore these decomposition products will remain in the solution and can be dealt with as part of the solvent disposal or re-purification. An important advantage of this present invention is the retention of decomposition products in the solution, thus preventing the decomposition products from being entrained in the gas stream going to the reaction chamber. In some cases, decomposition products may be insoluble in the solvent and therefore remain suspended. In the event that the decomposition product is volatile, it may be delivered with the solute precursor to downstream chambers. However, the degree of decomposition can be controlled by selecting stable solute precursors and the correct vaporization temperature. As noted, according to the present invention, stable solute precursors are applied in the vaporization temperature range of 15° C. to 300° C.

While the above discussion has been most specifically related to the use of source materials for semiconductor layer formation, the present invention is applicable to many other applications. In particular, the present invention is applicable for any application where it is desired to obtain significant quantities of the vapor phase of low-vapor pressure compounds. For example, in medical applications, it may be desirable to deliver medication to a patient in the form of a vapor, rather than by injection, ingestion or topical dermal application. Further, in many chemical processes, it is desirable to introduce a reagent in the form of a vapor as opposed to a solid, liquid or solution.

The following provides one example of ALD deposition of Hf based high-k and metal gates in accordance with the present invention. 1M of HfCl₄ is dissolved into BMIM⁺BF₄⁻ ionic liquid. Solution precursor is delivered at 15° C. and 50° C. to a vaporizer that operates at a temperature between 60° C. and 200° C. HfCl₄ precursor in vapor phase exits the vaporizer and is delivered into the reaction chamber. The ionic liquid remains in liquid state and is captured at the bottom of the vaporizer where it can be removed through a drain. The captured ionic liquid may be recycled and reused in making new precursor solutions. At the reaction chamber, HfCl₄ precursor reacts with either oxygen or nitrogen containing vapor reagents to form a layer of HfO₂ or HfNₓ material for high-K/metal gate applications. Additional precursors may be co-deposited with the Hf based material, such as Si, Al, C or H.

It is anticipated that other embodiments and variations of the present invention will become readily apparent to the skilled artisan in the light of the foregoing description, and it is intended that such embodiments and variations likewise be included within the scope of the invention as set out in the appended claims.

What is claimed:

1. A low volatility compound for use in a deposition process comprising a solvent and a solute wherein the solvent has a vapor pressure several orders of magnitude lower than the vapor pressure of the solute.

2. The compound of claim 1 wherein the vapor pressure of the solvent is two to three times lower than the vapor pressure of the solute.

3. The compound of claim 1 wherein the solvent remains in liquid form over a temperature range necessary for vaporization of the solute.

4. The compound of claim 3 wherein the temperature range is 15° C. to 300° C.

5. The compound of claim 1 wherein the concentration of solute in solvent is from 0.001 M up to the solubility limit.

6. The compound of claim 5 wherein the concentration of solute in solvent is from 0.01M to 1M.

7. The compound of claim 1 wherein the solvent is a room temperature ionic liquid having no measurable or a very low vapor pressure from ambient temperature to 400° C.

8. The compound of claim 7 wherein the ionic liquid comprises a bulky cation and a small anion, wherein the cation is a imidazolium, pyridinium, ammonium or phosphonium and the anion is tetrafluoroborate, hexafluorophosphate or chlorine.

9. The compound of claim 8 wherein the cation is 1-ethyl-3-methylimidazolium, 1-n-butyl-3-methylimidazolium or 1-butyl-1-methylpyrrolidinium bis(trifluoromethylsulfonyl)imide.

10. The compound of claim 1 wherein the solute is a metal compound.

11. The compound of claim 10 wherein the metal compound is HfCl₄ or TaCl₅.
